(19) United States
(12) Patent Application Publication
(10) Pub. No.: US 2026/0132907 A1
(43) Pub. Date: May 14, 2026

(54) EXTERIOR LAMPS WITH HEATED LENS FOR ANTI-CONDENSATION

(71) Applicant: Ford Global Technologies, LLC, Dearborn, MI (US)

(72) Inventors: Michael Robertson, West Bloomfield, MI (US); Venkatesh Krishnan, Canton, MI (US); Segundo Baldovino, Novi, MI (US); Aaron Bradley Johnson, ALLEN PARK, MI (US)

(21) Appl. No.: 18/947,082

(22) Filed: Nov. 14, 2024

(51) Int. Cl. F21S 45/60; F21S 45/20

(52) U.S. Cl. CPC F21S 45/60; F21S 45/20

(57) ABSTRACT

A lamp assembly includes an outer lens that is attachable to a vehicle structure and at least one heat inducing member that mounted to selected portions of the outer lens.

### TECHNICAL FIELD

This disclosure relates generally to an exterior lighting system for a vehicle, and more particularly to an exterior lighting system with a heated outer lens to reduce condensation.

### BACKGROUND

Vehicles include exterior lighting systems with front and rear lamps that are configured to illuminate surrounding areas of the vehicle. These front and rear lamps may naturally experience moisture, heat, and condensation conditions.

### SUMMARY

A lamp assembly according to an exemplary aspect of the present disclosure includes, among other things: an outer lens that is attachable to a vehicle structure; and at least one heat inducing member that mounted to selected portions of the outer lens.

In a further non-limiting embodiment of any lamp assembly, the lamp assembly includes a lamp housing mounted to the vehicle structure and defining an interior cavity; and at least one light component positioned within the interior cavity, and wherein the outer lens encloses the at least one light component within the lamp housing.

In a further non-limiting embodiment of any lamp assembly, the at least one heat inducing member comprises a heatable decal that is attached to an inward facing surface of the outer lens and that is only positioned about selected portions of an outer periphery of the outer lens.

In a further non-limiting embodiment of any lamp assembly, the heatable decal comprises a heater wire embedded in the heatable decal.

In a further non-limiting embodiment of any lamp assembly, the heatable decal comprises: a first decal portion mounted to extend about an upper portion of the outer periphery of the outer lens; a second decal portion mounted to extend about a lower portion of the outer periphery of the outer lens; and a jumper wire that connects the heater wire of the first decal portion to the heater wire of the second decal portion.

In a further non-limiting embodiment of any lamp assembly, the at least one heat inducing member comprises a micro-grid of wires embedded in the outer lens.

In a further non-limiting embodiment of any lamp assembly, the micro-grid of wires are positioned within a center area of the outer lens and/or within an outer peripheral area of the outer lens.

In a further non-limiting embodiment of any lamp assembly, the at least one heat inducing member comprises a dot-matrix pattern applied about an outer periphery of the outer lens.

In a further non-limiting embodiment of any lamp assembly, the dot-matrix pattern is comprised of markings that absorb solar energy and direct heat toward a center area of the outer lens.

In a further non-limiting embodiment of any lamp assembly, the lamp assembly includes a fan with resistive heater coils, and wherein the fan is positioned to direct heated air toward a lower area of an inner surface of the outer lens.

In a further non-limiting embodiment of any lamp assembly, the lamp assembly includes one or more controllers that selectively activate the at least one heat inducing member if at least one predetermined criteria is met.

In a further non-limiting embodiment of any lamp assembly, the at least one predetermined criteria includes at least a temperature, and including: at least one temperature sensor that measures a temperature of an environment that is external to a vehicle; and wherein the one or more controllers receive temperature data from the at least one temperature sensor and selectively activate the at least one heat inducing member if the temperature of the environment is less than a predetermined temperature.

In a further non-limiting embodiment of any lamp assembly, the at least one predetermined criteria further includes at least a humidity level of the environment that is external to the vehicle, and wherein the one or more controllers selectively activate the at least one heat inducing member if the humidity level is greater than a predetermined humidity level and the temperature of the environment is less than a predetermined temperature.

In a further non-limiting embodiment of any lamp assembly, the one or more controllers activate the at least one heat inducing member in response to a user request from a smart device.

A method according to an exemplary aspect of the present disclosure includes, among other things: providing an outer lens that is attachable to a vehicle structure; and mounting at least one heat inducing member to selected portions of the outer lens.

In a further non-limiting embodiment of any method, the method includes: forming the at least one heat inducing member as a heatable decal that is embedded with a heater wire; and attaching the heatable decal to an inward facing surface of the outer lens and positioning the heatable decal only about selected portions of an outer periphery of the outer lens.

In a further non-limiting embodiment of any method, the method includes: forming the at least one heat inducing member as a micro-grid of wires embedded in the outer lens, wherein the micro-grid of wires are positioned within a center area of the outer lens; and/or forming the at least one heat inducing member as a dot-matrix pattern applied about an outer periphery of the outer lens, wherein the dot-matrix pattern is comprised of markings that absorb solar energy and direct heat toward a center area of the outer lens.

In a further non-limiting embodiment of any method, the method includes selectively activating the at least one heat inducing member if at least one predetermined criteria is met.

In a further non-limiting embodiment of any method, the at least one predetermined criteria includes at least a temperature of an environment that is external to a vehicle and/or a humidity level of an environment that is external to a vehicle, and the method includes: selectively activating the at least one heat inducing member if the temperature of the environment is less than a predetermined temperature; and/or selectively activating the at least one heat inducing member if the humidity level is greater than a predetermined humidity level.

In a further non-limiting embodiment of any method, the method includes activating the at least one heat inducing member in response to a user request from a smart device.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a front view of an exterior light assembly on a front of a vehicle.

FIG. 2A is a rear view of an exterior light assembly with one example of a heated lens.

FIG. 2B is a schematic section view of the heated lens of FIG. 2A.

FIG. 3 is a perspective rear view of a lamp housing of the exterior light assembly with another example of a heated lens.

FIG. 4A is a rear view of an exterior light assembly with another example of a heated lens.

FIG. 4B is an enlarged view of a portion of the lens of FIG. 4A.

FIG. 5 is a rear view of an exterior light assembly with another example of a heated lens.

FIG. 6 is one example of a flow diagram for a process of controlling the heating of the lens.

FIG. 7 is another example of a flow diagram for a process of controlling the heating of the lens.

### DETAILED DESCRIPTION

This disclosure details a vehicle exterior lighting system including an outer lens that includes a heat inducing element to heat the outer lens to reduce condensation.

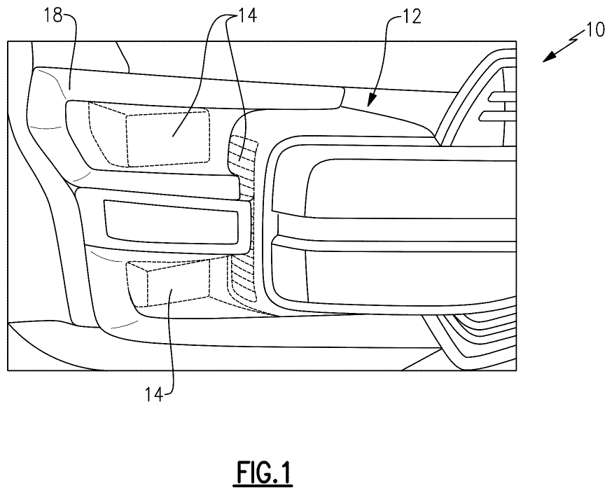

With reference to FIG. 1 a vehicle 10 includes an exterior light assembly 12 that has one or more light sources 14, e.g., LEDs, enclosed within a housing by an outer lens 18. In implementations, the exterior light assembly 12 can comprise any front, side and/or rear lamp that is configured to illuminate surrounding areas of the vehicle 10. Conditions such as moisture, heat, and condensation, for example, are a natural occurrence for all types of exterior lamps. If not evaporated effectively, over time this condensation can adversely affect lamp performance and operation.

In certain situations, condensation can form due to an imbalance of external heat and internal heat of the lamp. Further, depending on the amount of condensation, such as large water droplets, this condensation may remain for several days.

The subject disclosure provides a heating solution which performs well under many different types of conditions. In implementations, the disclosed heating solution is associated with the outer lens 18 and in certain configurations has the option to be actively controlled to provide optimal performance to alleviate condensation from forming.

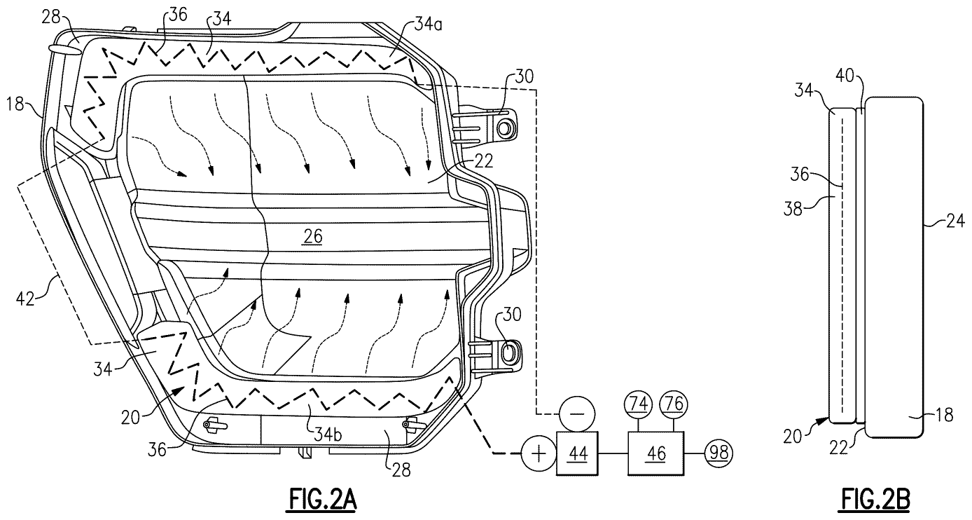

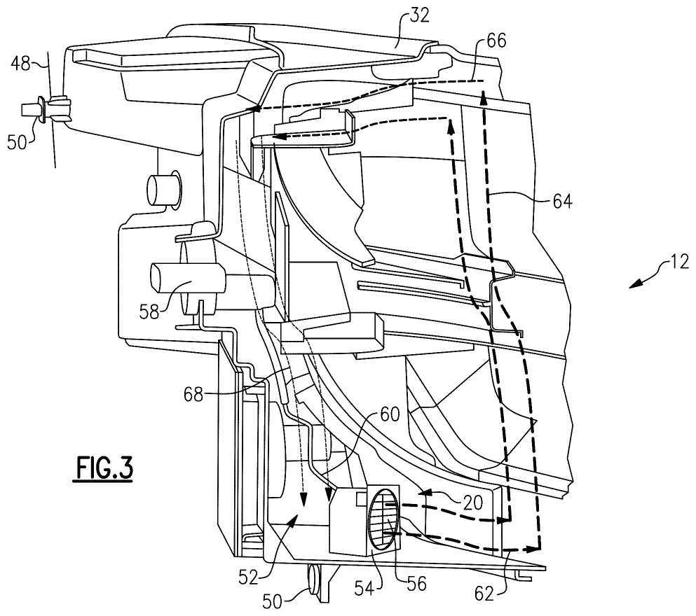

In one example shown in FIGS. 2A-B, the outer lens 18 includes at least one heat inducing member 20 that is mounted to selected portions of the outer lens 18. In implementations, the outer lens 18 has an inner surface 22 facing a vehicle interior direction and an outer surface 24 facing a vehicle exterior direction. The outer lens 18 also has a center area 26 and an outer peripheral area 28. The outer peripheral area 28 may include one or more mounting tabs 30 that are attachable to a vehicle structure and/or a lamp housing 32 (FIG. 3).

In implementations, the outer lens 18 has different zones/areas for visibility purposes. For example, a central zone comprises the center area 26 that should be visible to users, and which needs to remain clear. Additionally, an outer zone comprises the outer peripheral area 28, which is still part of the outer lens 18 but it is hidden by trim panels or dual shot black material that may be associated with the outer lens 18. The outer zone is the zone that predominately has condensation issues.

In implementations, one or more heater grid decals 34 are applied to the inner surface 22 of the outer lens 18. In one example, the heater grid decals 34 are added to the non-visible portion, e.g., the outer peripheral area 28, of the outer lens 18. Heat is radiated up into the visible portion, e.g., the center area 26, of the outer lens 18 to prevent/reduce condensation from forming inside of the outer lens 18.

In one example, the heater grid decal 34 is only positioned about selected portions of an outer peripheral area 28 of the outer lens 18.

In implementations, the heater grid decal 34 comprises a heater wire 36 embedded in a body 38 of the heater grid decal 34 as best shown in FIG. 2B.

In implementations, the heater grid decal 34 may be attached to the inner surface 22 of the outer lens 18 with adhesive 40.

In implementations, multiple heater grid decals 34 may be added in different locations, and then wired together. This ensures heat is distributed to all critical regions of the lens 18 to reduce condensation.

For example, in one configuration shown in FIG. 2A, the heater grid decal 34 comprises a first decal portion 34a mounted to extend about an upper portion of the outer peripheral area 28 of the outer lens 18 and a second decal portion 34b mounted to extend about a lower portion of the outer peripheral area 28 of the outer lens 18. A jumper wire 42 is then used to connect one end of the heater wire 36 of the first decal portion 34a to one end of the heater wire 36 of the second decal portion 34a. The opposite ends of the heater wires 36 are then connectable to a power source 44 via a positive (+) terminal connection and a negative (−) connection as shown in FIG. 2A.

In implementations, the power source 44 is associated with one or more controllers 46 to selectively activate the heater grid decals 34 in a heating mode. The one or more controllers 46 may include a processor, memory, and one or more input and/or output (I/O) device interface(s) that are communicatively coupled via a local interface. The local interface can include, for example but not limited to, one or more buses and/or other wired or wireless connections. The one or more controllers 46 may be a hardware device for executing software, particularly software stored in memory. The one or more controllers 46 can be a custom made or commercially available processor, a central processing unit (CPU), an auxiliary processor among several processors associated with the computing device, a semiconductor based microprocessor (in the form of a microchip or chip set) or generally any device for executing software instructions. The software in the memory may include one or more separate programs, each of which includes an ordered listing of executable instructions for implementing logical functions. The one or more controllers 46 can be configured to execute software stored within the memory, to communicate data to and from the memory, and to generally control operations of the computing device pursuant to the software. Those skilled in the art who have the benefit of this description will be able to determine the executable instructions that would be applied for these purposes.

As shown in FIG. 3, each exterior light assembly 12 includes a lamp housing 32 that is mountable to a vehicle structure 48 via a connection interface 50. The lamp housing 32 defines an interior cavity 52 and at least one light component or light source 14 (FIG. 1) is positioned within the interior cavity 52. The outer lens 18 encloses the light sources 14 within the lamp housing 32.

FIG. 3 also shows another example of a heat inducing member 20 that is associated with selected portions of the outer lens 18. In this example, a fan 54 with resistive heater coils 56 is connected to a power source 58 via a wire connection 60. In implementations, the fan 54 is positioned within the interior cavity 52 at the bottom of the lamp housing 32 to direct heated air toward a lower area of an inner surface 22 of the outer lens 18 as indicated at 62. The warm air is then blown towards the outer lens 18 and is then directed by the lens 18 upward to the top of the lens 18 as indicated at 64. As the heated air reaches the top area of the lamp housing 32, it cools and is channeled to a rear area of the lamp housing 32 as indicated at 66. The cooled air then drops/returns down toward the fan 54 and heater coils 56 for re-circulation as indicated at 68. Thus, a heated air circulation loop is created that keeps the outer lens from accumulation condensation.

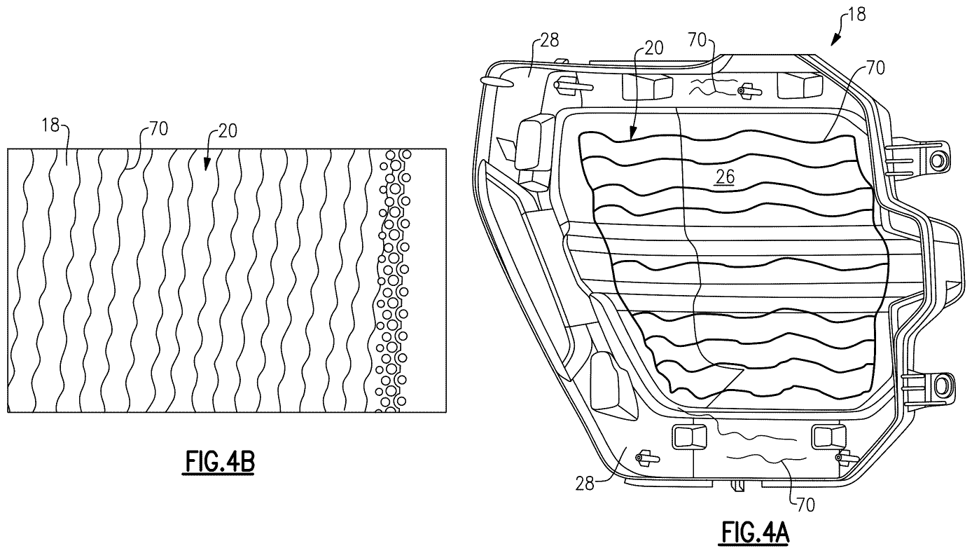

FIGS. 4A-B also show another example of a heat inducing member 20 that is mounted to the outer lens 18. In this example, the heat inducing member 20 comprises a micro-grid of wires 70 that are embedded in the outer lens 18. In one example, the micro-grid of wires 70 can be located only in the outer peripheral area 28 or only in the center area 26. In another example, the micro-grid of wires 70 can be located across the entire lens surface to heat the full lens 18 and not just the perimeter.

In implementations, the micro-grid of wires 70 provides heating elements in front of the optics without disrupting them. Thus, the micro-grid of wires 70 does not inhibit light output or beam patterns.

Micro-grid wires 70 typically comprise very thin conductive lines/wires embedded within a body formed from plastic or glass, for example. These wires heat up when electrical current passes through them, which then effectively transfers heat to the lens 18 to reduce or eliminate condensation.

As shown in FIG. 4B, the micro-grid wires 70 are only visible while looking at them in a magnified view. Thus, the wires do not impede visibility during normal use.

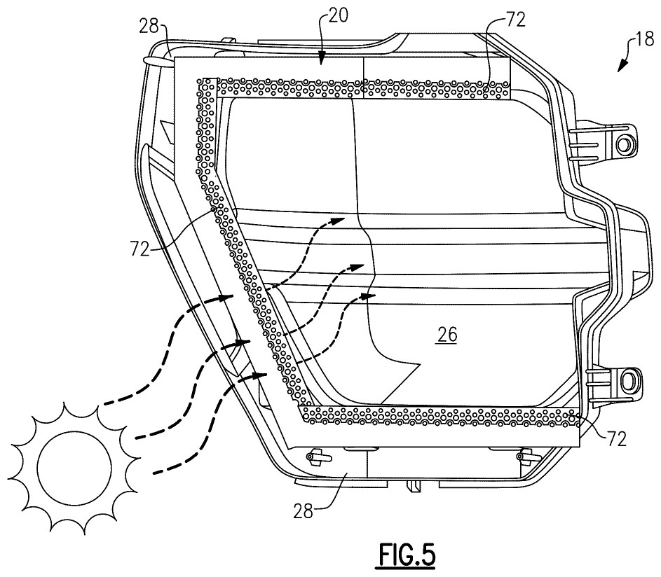

FIG. 5 also shows another example of a heat inducing member 20 that is mounted to the outer lens 18. In this example, the heat inducing member 20 comprises a dot-matrix pattern 72 that is applied about the outer peripheral area 28 of the outer lens 18.

In implementations, the dot-matrix pattern is comprised of markings that absorb solar energy and direct heat toward the center area 26 of the outer lens 18.

In implementations, the dot-matrix solar portions may comprise a grid of small dots or a patterned film applied to the lens 18. The dot-matrix solar portions may be made from materials that are both durable and effective in managing solar energy. Some examples of material that may be used include: polymer films that are applied to the lens 18; or ceramic or metal oxide coatings that can be integrated during the lens manufacturing process. The dot-matrix solar portions may also comprise a laminated lens structure where the dot-matrix pattern can comprise multiple layers that are fused together for added strength.

In implementations, the one or more controllers 46 selectively activate the heat inducing members 20 of the configurations shown in FIGS. 2A-B, FIG. 3, and FIGS. 4A-B if at least one predetermined criteria is met. For example, the at least one predetermined criteria may comprise at least a temperature determination.

In implementations, at least one temperature sensor 74 (FIG. 2A) is used to measure a temperature of an environment that is external to the vehicle 10. The one or more controllers 46 receive temperature data from the temperature sensor 74 and selectively activate the respective heat inducing member 20 if the temperature of the environment is less than a predetermined temperature.

In one example, the predetermined temperature is 21 degrees Celsius; however, other temperature levels may also be used.

In another example, the at least one predetermined criteria may comprise determining a humidity level of the environment that is external to the vehicle 10. One or more other sensors (FIG. 2A) 76 may be used to facilitate this determination. The one or more controllers 46 may then selectively activate the respective heat inducing member 20 if the humidity level is greater than a predetermined humidity level.

In one example, the predetermined humidity level is greater than 80%; however, other humidity levels may also be used.

In another example, the respective heat inducing member 20 is activated based on both the temperature and the humidity.

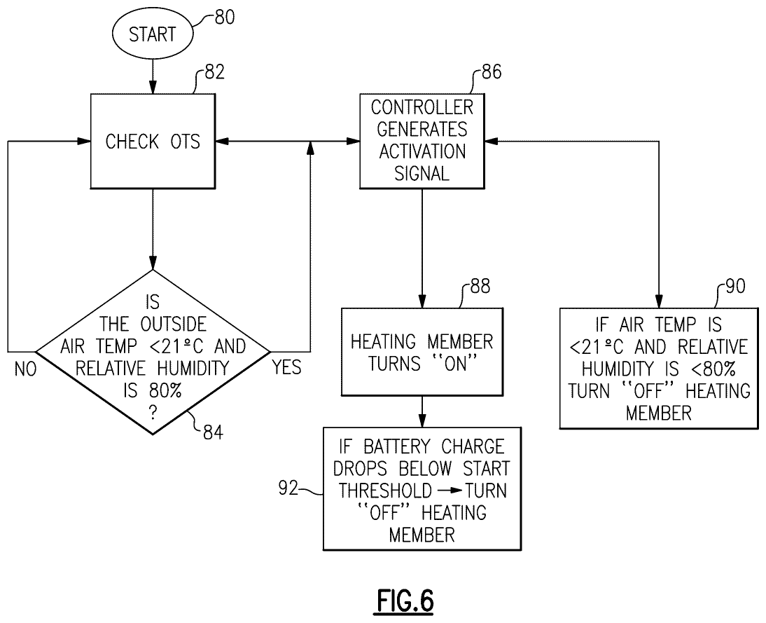

Such an example is shown in FIG. 6, which depicts one example of a flow diagram for a process of controlling the heating of the lens 18. In this example, the process starts at 80 with a determination of an outside temperature via the outside temperature sensor (OTS) 74 as indicated at 82. Next, at step 84, it is determined whether the outside temperature is greater than a predetermined temperature and whether the humidity is at or above a predetermined humidity level. If not, the process returns to step 82. If yes, the process proceeds to step 86 where the one or more controllers 46 activate the heat inducing member 20 as indicated at 88. The process continues to continuously monitor temperature and humidity, and at step 90, if the outside temperature is less than the predetermined temperature and the humidity is below the predetermined humidity level, then the controller 46 turns the heating member 20 off.

Additionally, in implementations, if it is determined that a vehicle battery charge has dropped below a starting threshold, the controller will automatically turn off the heating member 20 as indicated at 92.

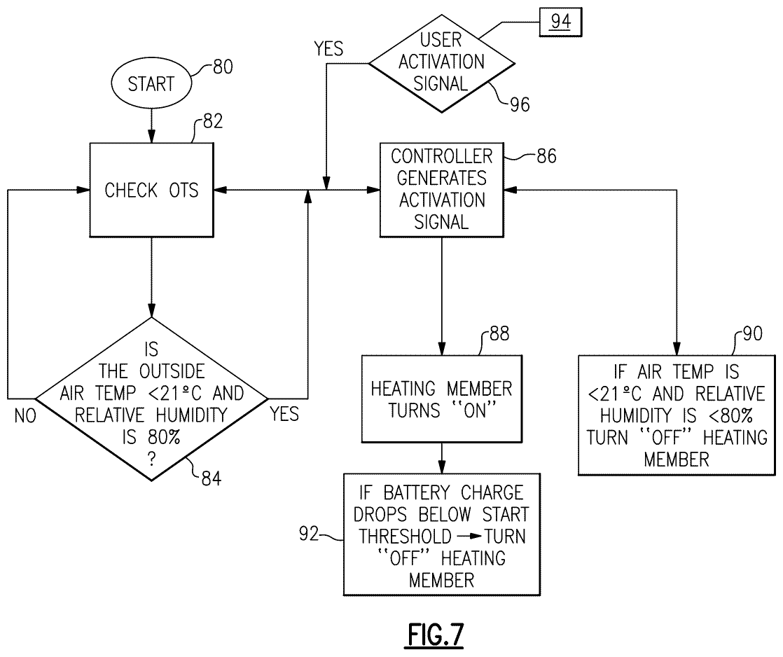

In implementations, the one or more controllers 46 may also activate the heat inducing member 20 in response to a user request from a smart device 94 such as a smart phone, for example. FIG. 7 depicts another example of a flow diagram for a process of controlling the heating of the lens 18 that includes the option for activation by a user. The flow diagram of FIG. 7 is the same as the flow diagram for FIG. 6 but includes an additional step 96 of allowing a user activation signal to be sent to the controller 46 independent of temperature and humidity sensing. Thus, this provides a user the option to override the temperature and humidity requirements. However, if it is determined that a vehicle battery charge has dropped below a starting threshold, the controller will override the user request and automatically turn off the heating member 20 as indicated at 92.

In implementations, different scenarios may be programmed into the controllers 46 to provide for automatic activation under certain conditions.

In implementations, the heat inducing members 20 may be programmed based on multiple sensor inputs to be continuously monitored and activated when needed in intervals to prevent condensation occurrence.

For example, when the vehicle 10 is parked and OFF, the heating member 20 may be operated at a low temperature for a certain amount of time, e.g., 5 minutes at 25-minute intervals, to distribute heat and airflow to reduce condensation. The activation time and intervals may be adjusted as need based on testing and/or other requirements.

In another example, when the windshield wipers are ON or a rain sensor 98 (FIG. 2A) detects rain, the heating member 20 may be operated at high temperature for a certain amount of time, e.g., 1 minute at 10-minute intervals, to distribute heat and airflow to reduce condensation. The activation time and intervals may be adjusted as need based on testing and/or other requirements.

In another example, activation can be based on ambient air temperature and time of day. For example, the heating member 20 may be operated at an increased temperature early in the morning and/or when temperatures are cooler, e.g., in the morning when the sun rises and starts to heat up a colder lamp.

The subject disclosure provides for heat inducing members 20 that are used to reduce or eliminate condensation in a light assembly 12. Various embodiments of heat inducing members 20 are disclosed. These embodiments may be used individually or in any combination.

The subject disclosure also provides a method for heating the outer lens. In implementations, the method includes providing an outer lens that is attachable to a vehicle structure, and mounting at least one heat inducing member to selected portions of the outer lens.

The method may further include any of the following steps either alone or in any combination thereof.

In one example, the method includes forming the at least one heat inducing member as a heatable decal that is embedded with a heater wire, and attaching the heatable decal to an inward facing surface of the outer lens and positioning the heatable decal only about selected portions of an outer periphery of the outer lens.

In one example, the method includes forming the at least one heat inducing member as a micro-grid of wires embedded in the outer lens, wherein the micro-grid of wires are positioned within a center area of the outer lens; and/or forming the at least one heat inducing member as a dot-matrix pattern applied about an outer periphery of the outer lens, wherein the dot-matrix pattern is comprised of markings that absorb solar energy and direct heat toward a center area of the outer lens.

In one example, the method includes selectively activating the at least one heat inducing member if at least one predetermined criteria is met.

In one example, the method includes wherein the at least one predetermined criteria includes at least a temperature of an environment that is external to a vehicle and/or a humidity level of an environment that is external to a vehicle, and the method including: selectively activating the at least one heat inducing member if the temperature of the environment is less than a predetermined temperature; and/or selectively activating the at least one heat inducing member if the humidity level is greater than a predetermined humidity level.

In one example, the method includes activating the at least one heat inducing member in response to a user request from a smart device.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

1. A lamp assembly, comprising:
an outer lens that is attachable to a vehicle structure; and
at least one heat inducing member that mounted to selected portions of the outer lens, wherein the at least one heat inducing member comprises a micro-grid of wires embedded in the outer lens.

2. The lamp assembly of claim 1, including:
a lamp housing mounted to the vehicle structure and defining an interior cavity; and
at least one light component positioned within the interior cavity, and wherein the outer lens encloses the at least one light component within the lamp housing.

3. A lamp assembly, comprising:
an outer lens that is attachable to a vehicle structure; and
at least one heat inducing member that mounted to selected portions of the outer lens, wherein the at least one heat inducing member comprises a heatable decal that is attached to an inward facing surface of the outer lens and that is only positioned about selected portions of an outer periphery of the outer lens.

4. The lamp assembly of claim 3, wherein the heatable decal comprises a heater wire embedded in the heatable decal.

5. The lamp assembly of claim 4, wherein the heatable decal comprises:
a first decal portion mounted to extend about an upper portion of the outer periphery of the outer lens;
a second decal portion mounted to extend about a lower portion of the outer periphery of the outer lens; and
a jumper wire that connects the heater wire of the first decal portion to the heater wire of the second decal portion.

6. The lamp assembly of claim 1, wherein the micro-grid of wires that are embedded in the outer lens comprise heating elements that are thin conductive lines or wires that are embedded within a body that forms the outer lens, and wherein the heating elements are positioned in front of lamp optics without disrupting the lamp optics such that the micro-grid of wires does not inhibit light output or beam patterns.

7. The lamp assembly of claim 6, wherein the micro-grid of wires are positioned within a center area of the outer lens and/or within an outer peripheral area of the outer lens.

8. A lamp assembly, comprising:
an outer lens that is attachable to a vehicle structure; and
at least one heat inducing member that mounted to selected portions of the outer lens, wherein the at least one heat inducing member comprises a dot-matrix pattern applied about an outer periphery of the outer lens.

9. The lamp assembly of claim 8, wherein the dot-matrix pattern is comprised of markings that absorb solar energy and direct heat toward a center area of the outer lens.

10. A lamp assembly, comprising:
an outer lens that is attachable to a vehicle structure;
at least one heat inducing member that mounted to selected portions of the outer lens; and
a fan with resistive heater coils, and wherein the fan is positioned to direct heated air toward a lower area of an inner surface of the outer lens.

11. The lamp assembly of claim 1, including:
one or more controllers that selectively activate the at least one heat inducing member if at least one predetermined criteria is met.

12. The lamp assembly of claim 11, wherein the at least one predetermined criteria includes at least a temperature, and including:
at least one temperature sensor that measures a temperature of an environment that is external to a vehicle; and
wherein the one or more controllers receive temperature data from the at least one temperature sensor and selectively activate the at least one heat inducing member if the temperature of the environment is less than a predetermined temperature.

13. The lamp assembly of claim 12, wherein the at least one predetermined criteria further includes at least a humidity level of the environment that is external to the vehicle, and wherein the one or more controllers selectively activate the at least one heat inducing member if the humidity level is greater than a predetermined humidity level and the temperature of the environment is less than a predetermined temperature.

14. The lamp assembly of claim 11, wherein the one or more controllers activate the at least one heat inducing member in response to a user request from a smart device.

15. A method comprising:
providing an outer lens that is attachable to a vehicle structure;
mounting at least one heat inducing member to selected portions of the outer lens; and
forming the at least one heat inducing member as a dot-matrix pattern applied about an outer periphery of the outer lens, wherein the dot-matrix pattern is comprised of markings that absorb solar energy and direct heat toward a center area of the outer lens.

16. A method comprising:
providing an outer lens that is attachable to a vehicle structure;
mounting at least one heat inducing member to selected portions of the outer lens;
forming the at least one heat inducing member as a heatable decal that is embedded with a heater wire; and
attaching the heatable decal to an inward facing surface of the outer lens and positioning the heatable decal only about selected portions of an outer periphery of the outer lens.

17. A method comprising:
providing an outer lens that is attachable to a vehicle structure;
mounting at least one heat inducing member to selected portions of the outer lens; and
forming the at least one heat inducing member as a micro-grid of wires embedded in the outer lens, wherein the micro-grid of wires are positioned within a center area of the outer lens and/or within an outer peripheral area of the outer lens.

18. The method of claim 15, including selectively activating the at least one heat inducing member if at least one predetermined criteria is met.

19. The method of claim 18, wherein the at least one predetermined criteria includes at least a temperature of an environment that is external to a vehicle and/or a humidity level of an environment that is external to a vehicle, and including:
selectively activating the at least one heat inducing member if the temperature of the environment is less than a predetermined temperature; and/or
selectively activating the at least one heat inducing member if the humidity level is greater than a predetermined humidity level.

20. The method of claim 15, including activating the at least one heat inducing member in response to a user request from a smart device.

21. The method of claim 17, including forming the micro-grid of wires as heating elements that are thin conductive lines or wires, embedding the heating elements within a body that forms the outer lens, and positioning the heating elements in front of lamp optics without disrupting the lamp optics such that the micro-grid of wires does not inhibit light output or beam patterns.
